(19) United States
(12) Patent Application Publication
(10) Pub. No.: US 2010/0002444 A1
(43) Pub. Date: Jan. 7, 2010

(54) Bulb-shaped led lamp and compact led lamp

(75) Inventor: Daijiro Konaka, Yokohama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM GESELLSCHAFT MIT BESCHRANKTER HAFTUNG, MUNICH (DE)

(21) Appl. No.: 12/311,124

(22) PCT Filed: Sep. 19, 2007
(86) PCT No.: PCT/JP2007/068131

§ 371 Date: May 6, 2009

(30) Foreign Application Priority Data
Sep. 20, 2006 (JP) 2006-253792

(51) Int. Cl. F21V 29/00

(52) U.S. Cl. 362/294

(57) ABSTRACT

A bulb-shaped LED lamp includes a plurality of high-intensity LED modules 2 where a high-intensity LED is attached on an LED fixing base plate, a heat sink 5 where the high-intensity LED modules 2 are attached on an end face in an axial direction thereof along a circumferential direction, for performing radiation of the high-intensity LED modules 2, a reflector 4 which is provided so as to surround the plurality of high-intensity LED modules 2, for guiding light from the high-intensity LED modules 2 forward, an electronic circuit for driving 6 which drives the high-intensity LED modules 2, a housing 7 which houses the heat sink 5, the electronic circuit for driving 6, and a portion of the reflector 4 therein, and a globe 8 which configures an outer shell together with the housing 7.

### TECHNICAL FIELD

The present invention relates to a bulb-shaped LED lamp and a compact LED lamp where light-emitting diodes (LEDs) are used as a light source.

### BACKGROUND ART

In order to make luminance of light wavelength-converted by a wave-conversion cover approximately even and achieve a long operating life of fluorescence substance and light-emitting diode devices, there has been proposed a LED bulb provided with an LED light-emitting portion having a plurality of light-emitting diode devices for emitting near-ultraviolet light or blue light, which are arranged in a plane manner, a flat face portion disposed at a position spaced from a face on which the light-emitting diode devices are arranged by a predetermined distance so as to face the light-emitting diode devices, and a wavelength-converting cover provided on its flat face portion with fluorescence substance for wavelength-converting light emitted from the light-emitting diode devices (for example, see Patent Reference 1).

### Patent Reference 1: JP-A-2006-156187

### DISCLOSURE OF THE INVENTION

### Problem to be Solved by the Invention

However, the LED lamp proposed above has the following problems.

Since a large amount of light emitted from the LED light-emitting portion of the LED bulb leaks from a glass globe laterally, it is impossible to take out light in a front direction efficiently.

The present invention has been made to solve the abovementioned problems and an object thereof is to provide a bulb-shaped LED lamp which improves brightness and can obtain brightness corresponding to a filament bulb of 40 watts to 60 watts and a compact LED lamp.

### Means for Solving the Problem

A bulb-shaped LED lamp according to the present invention comprises a plurality of high-intensity LED modules where a high-intensity LED is attached on an LED fixing base plate; a heat sink where the high-intensity LED modules are attached on one end face in an axial direction thereof along a circumferential direction, for performing radiation of the high-intensity LED modules; a reflector which is provided so as to surround the plurality of high-intensity LED modules, for guiding light from the high-intensity LED modules forward; an electronic circuit for driving which drives the high-intensity LED modules; a housing which houses the heat sink, the electronic circuit for driving, a portion of the reflector therein; and a globe which configures an outer shell together with the housing.

The bulb-shaped LED lamp according to the present invention has a configuration that a diffusion sheet is used as the reflector.

A bulb-shaped LED lamp according to the present invention comprises a plurality of high-intensity LED modules where a high-intensity LED is attached on an LED fixing base plate, each being provided around a high-intensity LED with a reflector for guiding light forward; a heat sink on which the high-intensity LED modules are attached on an end face in an axial direction thereof along a circumferential direction, for performing radiation of the high-intensity LED modules; an electronic circuit for driving which drives the high-intensity LED modules; a housing which houses the heat sink and the electronic circuit for driving; and a glass globe which configures an outer shell together with the housing.

A compact LED lamp according to the present invention comprises a plurality of high-intensity LED modules where a high-intensity LED is attached on an LED fixing base plate; a heat sink where the high-intensity LED modules are attached on an end face in an axial direction thereof along a circumferential direction, for performing radiation of the high-intensity LED modules; a reflector which is provided so as to surround the plurality of high-intensity LED modules, for guiding light from the high-intensity LED modules forward; a resin light-guiding blade member having the same number of blades as the number of high-intensity LED modules, where the blades are provided radially in a diametrical direction at approximately equal intervals, the blades have predetermined heights in the axial direction, and the respective blades are fixed on the high-intensity LED modules; an electronic circuit for driving which drives the high-intensity LED modules; and a housing which-houses the heat sink, the electronic circuit for driving, a portion of the reflector therein.

### EFFECT OF THE INVENTION

With the abovementioned configuration, the bulb-shaped LED lamp according to the present invention can achieve such an effect that brightness is improved and brightness corresponding to a filament bulb of 40 watts to 60 watts can be obtained according to improvement of luminance of the high-intensity LEDs.

In the compact LED lamp according to the present invention, light from the high-intensity LED modules can be taken out laterally and forward efficiently by the resin light-guiding blade member having the same number of blades as the number of the high-intensity LED modules.

### BRIEF DESCRIPTION OF THE DRAWINGS

FIG. 1 shows a first embodiment and a front view of a bulb-shaped LED lamp 1.

FIG. 2 shows the first embodiment and a sectional view taken along line A-A in FIG. 1.

FIG. 3 shows a second embodiment and a front view of a compact LED lamp 10.

FIG. 4 shows the second embodiment and a plan view of the compact LED 10 lamp viewed from the front thereof.

FIG. 5 shows a third embodiment and a plan view of a bulb-shaped LED lamp 1.

FIG. 6 shows the third embodiment and a sectional view taken along line B-B in FIG. 5.

### EXPLANATION OF REFERENCE NUMERALS

1: bulb-shaped LED lamp, 2: high-intensity LED module, 2a: high-intensity LED, 2b: LED fixing base plate, 2c: reflecting plate, 4: reflector, 5: heat sink, 6: electronic circuit for driving, 7: housing, 8: globe, 9: E26 base, 10: compact LED lamp, 11: resin light-guiding blade member, 11a: blade

### BEST MODE FOR CARRYING OUT THE INVENTION

### First Embodiment

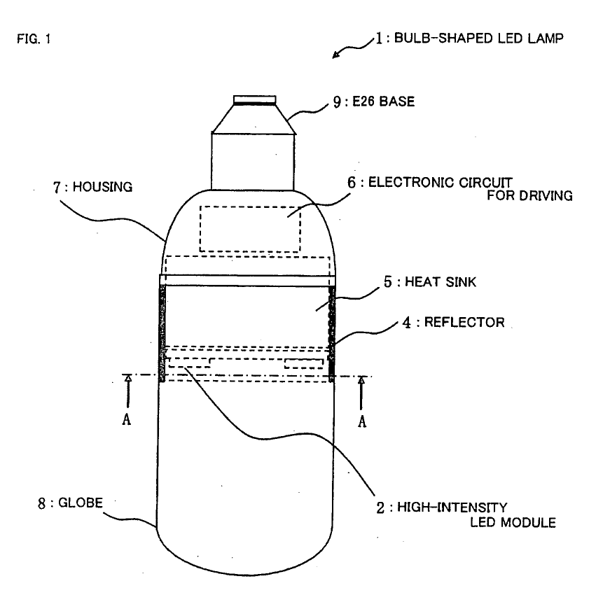

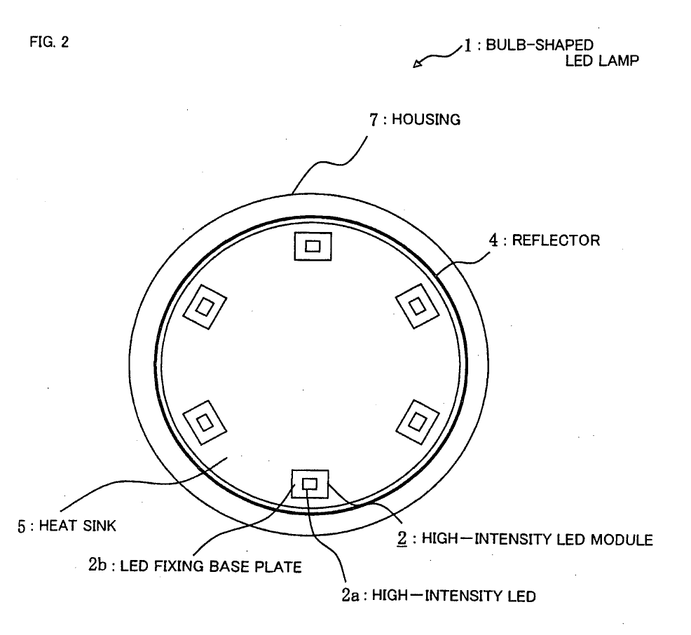

FIG. 1 and FIG. 2 show a first embodiment. FIG. 1 shows a front view of a bulb-shaped LED lamp 1 and FIG. 2 shows a sectional view taken along line A-A in FIG. 1.

As shown in FIG. 1 and FIG. 2, a light source of the bulb-shaped LED lamp 1 is a high-intensity LED module 2 where a high-intensity LED 2a is attached on an LED fixing base plate 2b. Six high-intensity LED modules 2 are used here. Brightness of the high-intensity LED 2a has 20 lm (lumen) per one piece at present, and the brightness reaches only 120 lm even when six high-intensity LEDs are used, but it is expected that luminance of the high-intensity LED 2a is rapidly raised in the near future. For example, when the brightness of the high-intensity LED 2a reaches a value corresponding to 100 lm per one piece, illuminance corresponding to a filament bulb of 40 to 60 watts is obtained under such a condition that a distance between a subject and the bulb-shaped LED lamp 1 is in a range of 1 m to 2 m and a distance in circumferential direction is about 2 m by the bulb-shaped LED lamp 1 of a configuration in FIG. 1 and FIG. 2.

Six high-intensity LED modules 2 are arranged and fixed on an end face of a heat sink 5 in an axial direction thereof along a circumferential direction. LED fixing base plates 2b are fixed on the heat sink 5 by adhesive or the like. The LED fixing base plate 2b is made from metal, polyimide resin, or the like. The heat sink 5 is a radiator plate made from, for example, aluminum, and heat generated from the high-intensity LED module 2 is transmitted and radiated efficiently.

A housing 7 is provided so as to surround the heat sink 5. The housing 7 is made from PBT (polybutylene terephthalate) resin or such metal as aluminum. The housing 7 is provided therein with not only the heat sink 5 but also an electronic circuit for driving 6 that adjusts power taken in from an external power source to current/voltage for lighting each high-intensity LED 2a to supply the same to each high-intensity LED 2a. Since the electronic circuit for driving 6 is a known one, explanation thereof is omitted.

The respective high-intensity LED modules 2 are surrounded by a reflector 4 optimized for efficiently taking out light from each high-intensity LED 2a forward. The reflector 4 is made of, for example, a diffusion sheet made from polycarbonate (PC), molded resin, or metal such as stainless steel. Lateral leakage of light from the high-intensity LEDs 2a is suppressed by the reflector 4, so that light can be efficiently taken out forward.

A globe 8 is attached to the outside of the reflector 4, and it configures an outer shell of a bulb-shaped LED lamp together with the housing 7. Material of the globe 8 is resin, glass, or the like. The housing 7 is attached with an E26 base. An E17 base may be used instead of the E26 base.

When the housing 7 is made from resin, radiation from resin surface is insufficient, so that thermally-conductive silicon rubber is filled in the housing 7, thereby coupling the heat sink 5 and the E26 base 9 thermally.

As described above, since the bulb-shaped LED lamp 1 according to the present embodiment uses the high-intensity LED modules 2, where light can be taken out forward efficiently by the reflector 4 suppressing lateral leakage of light from the high-intensity LEDs 2a, it is expected that, when luminance of a high-intensity LED2a is raised in the future, illuminance corresponding to a filament bulb of 40 to 60 watts can be obtained under such a condition that a distance between a subject and the bulb-shaped LED lamp 1 is in a range of 1 m to 2 m and a distance in a circumferential direction is about 2 m.

### Second Embodiment

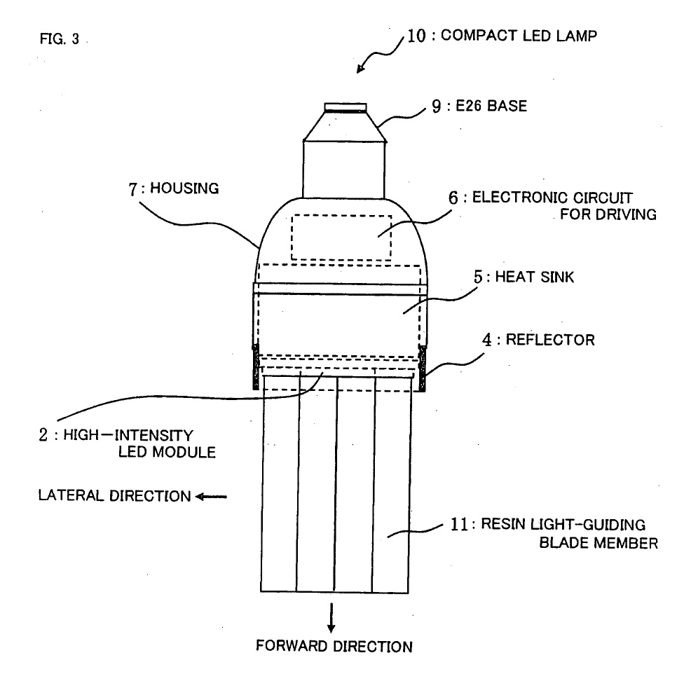

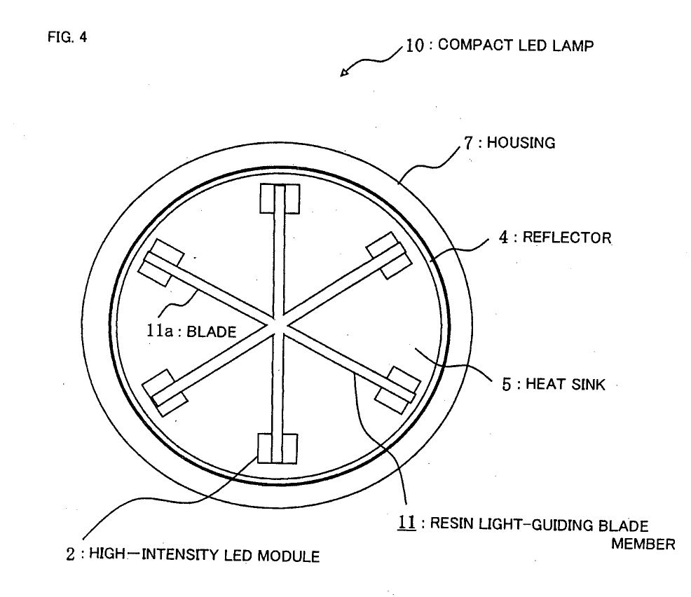

FIG. 3 and FIG. 4 show a second embodiment. FIG. 3 shows a front view of a compact LED lamp 10 and FIG. 4 shows a plan view of the compact LED lamp 10 viewed from the front thereof.

The compact LED lamp 10 is different from the bulb-shaped LED lamp 1 in FIG. 1 in that the former does not have the globe 8 and it is provided with a resin light-guiding blade member 11. The other configuration of the second embodiment is the same as that of the first embodiment.

The resin light-guiding blade member 11 has six blades 11a as shown in FIG. 4, where the blades 11a are provided radially in a diametrical direction at almost equal intervals. The blades 11a are set to predetermined heights in an axial direction (a height direction). Each blade 11a is bonded and fixed on the high-intensity LED module 2. Light from the high-intensity LED modules 2 is guided efficiently by the resin light-guiding blade member 11 so that light can be taken out in a lateral direction (a diametrical direction) and in a forward direction. The resin light-guiding blade member 11 serves to diffuse light from the high-intensity LED modules 2 properly and serves to guide the light.

As described above, the compact LED lamp 10 according to the present embodiment can take out light from the high-intensity LED modules 2 in a lateral direction and a forward direction by the resin light-guiding blade member 11 having the same number of blades as the number of high-intensity LED modules 2.

### Third Embodiment

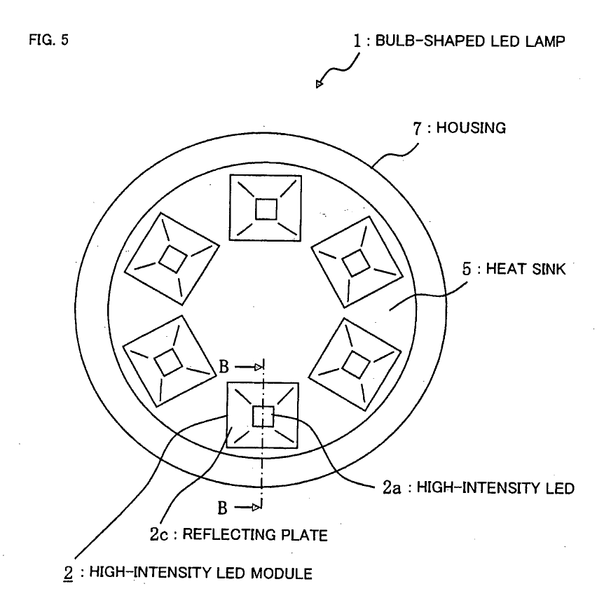

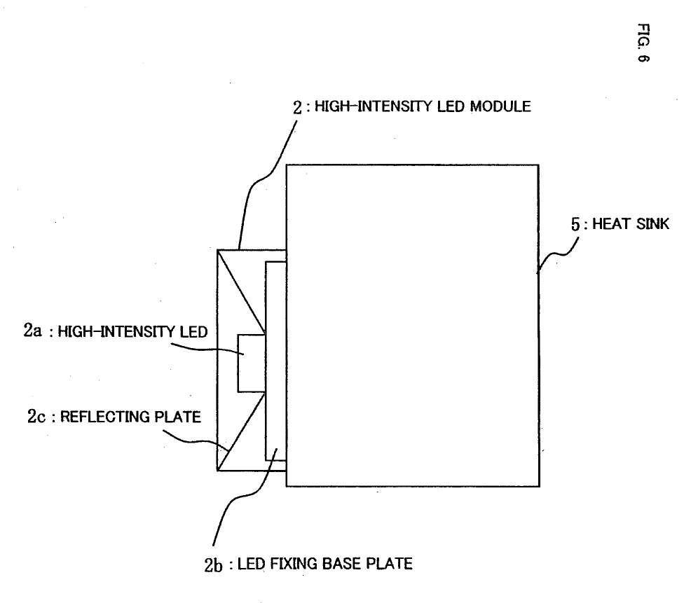

FIG. 5 and FIG. 6 show a third embodiment. FIG. 5 shows a plan view of a bulb-shaped LED lamp 1 and FIG. 6 shows a sectional view taken along line B-B in FIG. 5.

In the first embodiment, the reflector 4 is provided so as to surround all of the high-intensity LED modules 2, but reflecting plates 2c may be provided for individual high-intensity LED modules 2 instead of the reflector 4.

As shown in FIG. 5, six high-intensity LED modules 2 each have a horn-shaped reflecting plate 2c for guiding light forward around the high-intensity LED 2a. Since each high-intensity LED module 2 has the reflecting plate 2c for guiding light forward, the reflector 4 may be removed.

As shown in FIG. 6, in the high-intensity LED module 2, the high-intensity LED 2a is provided on the LED fixing base plate 2b and the horn-shaped reflecting plate 2c is provided around the high-intensity LED 2a. The LED fixing base plate 2b is bonded and fixed to the heat sink 5 by, for example, a double-faced adhesive tape.

As described above, in the bulb-shaped LED lamp 1 according to the present embodiment, the horn-shaped reflecting plates 2c for guiding light forward are provided around the high-intensity LEDs 2a of the individual high-intensity LED modules 2, thereby the reflector 4 used in the first embodiment can be removed.

However, both the horn-shaped reflecting plates 2c for guiding light forward provided around the high-intensity LEDs 2a of the individual high-intensity LED modules 2 and the reflector 4 surrounding all of the high-intensity LED modules 2 may be used.

1. A bulb-shaped LED lamp comprising:
a plurality of high-intensity LED modules where a high-intensity LED is attached on an LED fixing base plate;
a heat sink where the high-intensity LED modules are attached on an end face in an axial direction thereof along a circumferential direction, for performing radiation of the high-intensity LED modules;
a reflector which is provided so as to surround the plurality of high-intensity LED modules, for guiding light from the high-intensity LED modules forward;
an electronic circuit for driving which drives the high-intensity LED modules;
a housing which houses the heat sink, the electronic circuit for driving, a portion of the reflector therein; and
a globe which configures an outer shell together with the housing.

2. The bulb-shaped LED lamp according to claim 1, wherein a diffusion sheet is used as the reflector.

3. A bulb-shaped LED lamp comprising:
a plurality of high-intensity LED modules where a high-intensity LED is attached on an LED fixing base plate, each being provided around a high-intensity LED with a reflecting plate for guiding light forward;
a heat sink where the high-intensity LED modules are attached on an end face in an axial direction thereof along a circumferential direction, for performing radiation of the high-intensity LED modules;
an electronic circuit for driving which drives the high-intensity LED modules;
a housing which houses the heat sink and the electronic circuit for driving therein; and
a glass globe which configures an outer shell together with the housing.

4. A compact LED lamp comprising:
a plurality of high-intensity LED modules where a high-intensity LED is attached on an LED fixing base plate;
a heat sink where the high-intensity LED modules are attached on an end face in an axial direction thereof along a circumferential direction, for performing radiation of the high-intensity LED modules;
a reflector which is provided so as to surround the plurality of high-intensity LED modules, for guiding light from the high-intensity LED modules forward;
a resin light-guiding blade member having the same number of blades as the number of high-intensity LED modules, where the blades are provided radially in a diametrical direction at approximately equal intervals, the blades have predetermined heights in the axial direction, and the respective blades are fixed on the high-intensity LED modules;
an electronic circuit for driving which drives the high-intensity LED modules; and
a housing which houses the heat sink, the electronic circuit for driving, a portion of the reflector therein.
